(19) United States
(12) Patent Application Publication
(10) Pub. No.: US 2010/0309486 A1
(43) Pub. Date: Dec. 9, 2010

(54) PATTERN TRANSFER APPARATUS AND METHOD OF MANUFACTURING DEVICE

(75) Inventors: Masanori Numata, Yokohama-shi (JP); Shinichiro Koga, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/793,654

(22) Filed: Jun. 3, 2010

(30) Foreign Application Priority Data
Jun. 4, 2009 (JP) 2009-135353

(51) Int. Cl. G01B 11/14

(52) U.S. Cl. 356/620

(57) ABSTRACT

An apparatus performs an alignment measurement for a mark of each of at least two shots selected from a plurality of shots on a substrate, and positions the substrate based on the alignment measurements to transfer a pattern to each the plurality of shots. The apparatus comprises a detector configured to detect the mark and a controller configured to control the alignment measurements. The controller is configured to cause the detector to detect two of the mark, and decide whether the alignment measurements include an erroneous measurement based on whether a distance between the two of the mark detected by the detector is outside a tolerance.

### BACKGROUND OF THE INVENTION

1. Field of the Invention

The present invention relates to a pattern transfer apparatus and a method of manufacturing a device.

2. Description of the Related Art

In recent years, to keep up with advance in micropatterning and an increase in packing density of semiconductor devices such as an integrated circuit and a large-scale integration and liquid crystal display panels, exposure apparatus have become more precise and more sophisticated in functionality. Exposure apparatus called a stepper and a scanner are commonly used to manufacture such semiconductors. These apparatus sequentially transfer a pattern formed on an original (e.g., a reticle) to a plurality of portions on a substrate (e.g., a wafer) while moving the substrate in steps. An apparatus that performs this transfer by full-field exposure is called a stepper, whereas one that performs this transfer while scanning stages is called a scanner. An exposure apparatus including two wafer stages which hold substrates has recently been proposed to meet two requirements for improvements in both overlay precision and throughput. This exposure apparatus includes separate stations, an exposure station for exposing a wafer and a measurement station for measuring the wafer focus position and alignment position. This exposure apparatus can perform a measurement process for one wafer in the measurement station while it performs an exposure process for another wafer in the exposure station. Such an exposure apparatus is expected to overlay an original and a substrate on the order of nanometers in their alignment. Wafer position measurement will be exemplified herein as substrate position measurement included in alignment as one process. Although an original will be referred to as a reticle and a substrate will be referred to as a wafer hereinafter for the sake of easy explanation in the following description, including embodiments as well, an original and a substrate are not limited to a reticle and a wafer.

Wafer position measurement includes two types of processes, pre-alignment measurement and fine alignment measurement. The pre-alignment measurement serves to detect the amount of shift that occurs once a wafer is placed from a conveyance device onto a wafer chuck formed on a stage inside an exposure apparatus, and coarsely position the wafer to fall within a precision that allows normal processing of the subsequent fine alignment measurement. The fine alignment measurement is used to precisely measure the position of the wafer placed on the wafer chuck on the stage, and precisely position the wafer so that it is aligned with the reticle. A wafer 5 has an array of shots 1001 formed on it, which serve as the reticle pattern transfer regions and are exposed in the preprocess, as shown in FIG. 7. These shots 1001 normally have identical patterns formed in them, and alignment marks with the same shape are formed at identical positions in all shots. A shot to measure the alignment mark (to be referred as a measurement shot hereinafter) is selected from the shots 1001 arrayed in a predetermined pattern, and the wafer is aligned by measuring the position of each alignment mark of each measurement shot on the wafer. For example, reference numeral 1002 denotes a pre-alignment measurement shot; and 1003, a fine alignment measurement shot in FIG. 8. FIG. 9 is a schematic view illustrating an example of the arrangement of alignment marks in each shot. Reference symbol 1003 denotes an actual pattern region (circuit pattern region) within a shot. An alignment mark for use in pre-alignment measurement (to be simply referred to as a pre-alignment mark hereinafter) 1004 is located on a scribe line around the actual pattern region 1003 and has, for example, a shape shown in FIG. 10. Also, an alignment mark for use in fine alignment measurement (to be simply referred to as a fine alignment mark hereinafter) 1005 has, for example, a shape shown in FIG. 11. The alignment mark is the pattern formed in the preceding process, and is observed via a photosensitive film (resist) applied on the wafer. When a transparent film is formed after the formation of an alignment mark, the alignment mark can be observed even when it is not formed in the immediately preceding process.

A method of measuring these alignment marks will be described next. To sense and measure the alignment marks, they need to be moved to the field of view of a detection system and stand still thereafter. To meet this requirement, a wafer stage which holds the wafer is moved and stands still thereafter. This operation is repeated in the sequence indicated by, for example, arrows in FIG. 8. The arrows in FIG. 8 schematically indicate the movement of the field of view of the alignment detection system. However, in practice, the alignment detection system is fixed and the wafer, that is, the alignment mark relatively moves in the directions opposite to those indicated by the arrows. In pre-alignment measurement, one pre-alignment mark in each of two shots is generally measured. The user presets, the number of fine alignment marks to be measured, in accordance with the overlay precision necessary for a wafer to be exposed. After the measurement of the pre-alignment mark, respective measurement values are statistically computed to calculate the wafer shift, the wafer rotation, and the wafer magnification (the reduction ratio or the enlargement ratio) that represent the position and shape of the wafer (the shot array on the wafer). In fine alignment, the stage position where a fine alignment mark is sensed is determined based on the wafer position and shape measured in the pre-alignment measurement, and the fine alignment mark is measured. After the measurement of the fine alignment marks is completed, respective measurement values are statistically computed to calculate the position and shape of the wafer (the shot array on the wafer), and the calculation results are reflected on the exposure. Japanese Patent Laid-Open No. 9-218714 discloses details of such a technique.

To detect a wafer shift that occurs when the conveyance device conveys a wafer onto the chuck, as described earlier, pre-alignment measurement requires detection over a range wider than that in fine alignment measurement and typically has a detection range of about 500 μm². The position of the wafer in two orthogonal directions (in the X and Y directions) is measured using one mark within the above-mentioned detection range. A pattern matching process is commonly used for the pre-alignment measurement. The pattern matching process is roughly classified into two types of methods. One method binarizes an image, matches it with a template prepared in advance, and determines a position where highest correlation is obtained as a mark position. Another method calculates correlation with a template having grayscale information using a grayscale image intact. A normalization correlation method, for example, is often used as the latter method. Japanese Patent Laid-Open No. 2003-338455 discloses details of such a pattern matching process.

As described above, position alignment, which adopts pre-alignment and fine alignment, is an excellent scheme that can obtain a high throughput and high precision. On the other hand, these days, a planarization technique that adopts a polishing process called CMP (Chemical Mechanical Polishing) is commonly used. The surface layer of the alignment mark is polished upon CMP, and this often results in deterioration and a decrease in stability of the alignment mark. If the alignment mark that has deteriorated as in this case is measured, a desired shape pattern cannot be detected, so a pattern matching process may fail or a similar pattern around the alignment mark may be erroneously measured.

As described earlier, identical patterns are formed in respective shots, and alignment marks which have the same shape and located at identical positions in the shots are used in pre-alignment measurement which uses two alignment marks. For this reason, two alignment marks for use in pre-alignment measurement have the same mark and peripheral pattern shapes and may likewise be erroneously measured. This may make it impossible to detect the erroneous measurement in the pre-alignment. In this case, the process advances to the subsequent fine alignment measurement but stops because measurement is impossible in this state. Although an exposure process is not performed without redoing the overlay that has previously failed, the process advances to fine alignment measurement without redoing the measurement that has previously resulted in the erroneous measurement in the pre-alignment, leading to a decrease in productivity of the exposure apparatus.

### SUMMARY OF THE INVENTION

The present invention provides, for example, a pattern transfer apparatus advantageous in terms of deciding whether alignment measurements includes an erroneous measurement that leads to a decrease in productivity.

According to the present invention, there is provided an apparatus which performs an alignment measurement for a mark of each of at least two shots selected from a plurality of shots on a substrate, and positions the substrate based on the alignment measurements to transfer a pattern to each the plurality of shots, the apparatus comprising: a detector configured to detect the mark; and a controller configured to control the alignment measurements, wherein the controller is configured to cause the detector to detect two of the mark, and decide whether the alignment measurements include an erroneous measurement based on whether a distance between the two of the mark detected by the detector is outside a tolerance.

Further features of the present invention will become apparent from the following description of exemplary embodiments with reference to the attached drawings.

### BRIEF DESCRIPTION OF THE DRAWINGS

FIG. 1 is a flowchart of pre-alignment measurement in the first embodiment;

FIG. 2 is a schematic view illustrating one example of an exposure apparatus;

FIG. 3 is a schematic view illustrating one example of the measurement sequence of pre-alignment marks;

FIG. 4 is a schematic view illustrating one example of a shot;

FIG. 5 is a flowchart of pre-alignment measurement in the second embodiment;

FIG. 6 is a flowchart of pre-alignment measurement in the third embodiment;

FIG. 7 is a schematic view illustrating one example of a wafer;

FIG. 8 is a schematic view illustrating one example of the measurement sequences of pre-alignment marks and fine alignment marks;

FIG. 9 is a schematic view illustrating one example of a shot;

FIG. 10 is a schematic view illustrating one example of a pre-alignment mark; and

FIG. 11 is a schematic view illustrating one example of a fine alignment mark.

### DESCRIPTION OF THE EMBODIMENTS

### First Embodiment

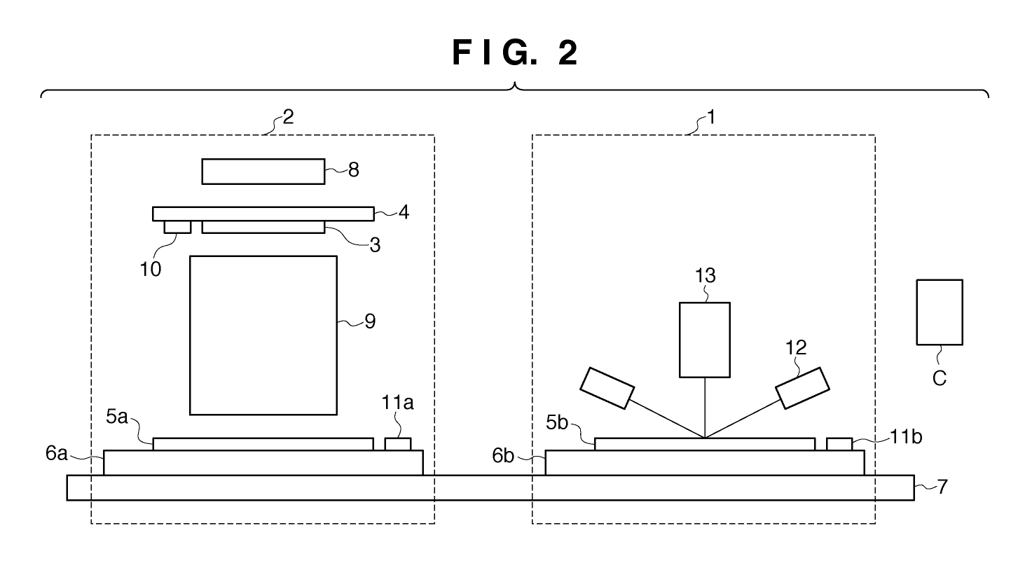

An exposure apparatus serving as a pattern transfer apparatus according to the first embodiment will be described with reference to FIG. 2. The exposure apparatus according to the first embodiment includes a measurement station 1 and exposure station 2. The exposure station 2 includes a reticle stage 4 which supports a reticle 3, two wafer stages 6a and 6b which support substrates (wafers) 5a and 5b and can move between the two stations, and a top plate 7 which supports the two wafer stages 6. The exposure apparatus also includes an illumination optical system 8 which illuminates the reticle 3 supported by the reticle stage 4 with exposure light, and a projection optical system 9 which projects the pattern of the reticle 3 illuminated with exposure light onto the wafer 5a on the wafer stage 6. A controller C which systematically controls the overall operation of the exposure apparatus is moreover used. Although the exposure apparatus in this embodiment includes the two wafer stages 6, it may include one or three or more wafer stages 6. A case in which the exposure apparatus used is a scanning exposure apparatus (scanner) which transfers by exposure a pattern formed on the reticle 3 to the wafer 5 while moving (scanning) the reticle 3 and wafer 5 in synchronism with each other in the scanning direction will be exemplified herein. The exposure apparatus used may, however, be a full-field transfer exposure apparatus (stepper), as a matter of course. In the following description, a direction which matches that of the optical axis of the projection optical system 9 is defined as the Z-axis direction, the direction (scanning direction) to move the reticle 3 and wafer 5 in synchronism with each other in a plane perpendicular to the Z-axis direction is defined as the Y-axis direction, and a direction (non-scanning direction) perpendicular to both the Z- and Y-axis directions is defined as the X-axis direction. Also, the rotation directions about the X-, Y-, and Z-axes are defined as the θX, θY, and θZ directions, respectively.

A predetermined illumination region on the reticle 3 is illuminated with exposure light having a uniform illuminance distribution by the illumination optical system 8. Although the exposure light emitted by the illumination optical system 8 is generally light of a mercury lamp, KrF excimer laser, ArF excimer laser, F₂ laser, or EUV (Extreme Ultra Violet) light source, it may be another exposure light. The reticle stage 4 supports the reticle 3. The reticle stage 4 can move two-dimensionally in a plane perpendicular to the optical axis of the projection optical system 9, that is, in the X-Y plane, and finely rotate in the θZ direction. A driving unit (not shown) such as a linear motor drives the reticle stage 4 and can be controlled by the controller C. A mirror is mounted on the reticle stage 4. A laser interferometer (not shown) is set at a position opposite to the mirror. The laser interferometer measures a rotation angle θZ and the position, in the two-dimensional direction within the X-Y plane, of the reticle 3 on the reticle stage 4 in real time, and outputs the measurement results to the controller C. The controller C can position the reticle 3, supported by the reticle stage 4, by driving the driving unit for the reticle stage 4 based on the measurement results obtained by the laser interferometer.

The projection optical system 9 projects the pattern of the reticle 3 to the wafer 5 at a predetermined projection magnification β, and includes a plurality of optical elements, which are supported by a lens barrel serving as a metal member. In this embodiment, the projection optical system 9 is a reduction projection system with a projection magnification β of, for example, ¼ or ⅕. Each wafer stage 6 supports the wafer 5, and includes a Z stage that holds the wafer 5 via a wafer chuck, an X-Y stage that supports the Z stage, and a base that supports the X-Y stage. A driving unit (not shown) such as a linear motor drives the wafer stage 6 and can be controlled by the controller C. A mirror, which moves together with the wafer stage 6, is mounted on the wafer stage 6. A laser interferometer (not shown) is set at a position opposite to the mirror. The laser interferometer measures a rotation angle θZ and the position, in the X and Y directions, of the wafer stage 6 in real time, and outputs the measurement results to the controller C. The laser interferometer also measures rotation angles θX and θY and the position, in the Z direction, of the wafer stage 6 in real time, and outputs the measurement results to the controller C. The controller C positions the wafer 5, supported by the wafer stage 6, by adjusting the position of the wafer 5 in the X, Y, and Z directions by driving the X-Y stage and the Z stage via the driving unit for the wafer stage 6 based on the measurement results obtained by the laser interferometer. A reticle alignment detection system (not shown) is set near the reticle stage 4. The reticle alignment detection system detects stage reference marks 11, that is, 11a and 11b formed on the wafer stages 6 via the projection optical system 9 and a reticle reference mark 10 formed on the reticle stage 4. The stage reference mark 11 is aligned with respect to the reticle reference mark 10 using the reticle alignment detection system.

The measurement station 1 includes a focus detection system 12 which detects the surface position information (the position information in the Z-axis direction and the tilt information) of the wafer 5, and a wafer alignment detection system 13 which detects the positions of the wafer 5 and stage reference mark 11. The focus detection system 12 includes a light projecting system which projects detection light onto the surface of the wafer 5, and a light receiving system which receives the light reflected by the wafer 5. The detection results (measurement values) obtained by the focus detection system 12 are output to the controller C. The controller C adjusts the tilt angle and the position (focus position), in the Z-axis direction, of the wafer 5, held by the Z stage, by driving the Z stage based on the detection results obtained by the focus detection system 12. Also, the position detection results (measurement values) of the wafer 5 and stage reference mark 11 obtained by the wafer alignment detection system 13 are output to the controller C as alignment position information within a coordinate system defined by the laser interferometer. The stage reference mark 11 is placed nearly flush with the surface of the wafer 5, and used to detect the reticle and wafer positions by the reticle alignment detection system and the wafer alignment detection system 13. Also, the stage reference mark 11 has a nearly flat surface portion and serves as a reference surface of the focus detection system 12. Stage reference marks 11 may be located at a plurality of corners of the wafer stage 6.

The wafer 5 includes a plurality of wafer alignment marks detected by the wafer alignment detection system 13. The plurality of wafer alignment marks are formed in the peripheries of respective shot regions on the wafer 5, and the positional relationships (in the X and Y directions) of the wafer alignment marks and the shot regions are assumed to be known. The exposure apparatus including two such wafer stages can, for example, load and measure a second wafer 5 on the wafer stage 6 in the measurement station 1 while it exposes a first wafer 5 on the wafer stage 6 in the exposure station 2. After the respective operations are completed, as the wafer stage 6 in the exposure station 2 moves to the measurement station 1, the wafer stage 6 in the measurement station 1 moves to the exposure station 2, and the second wafer 5 is exposed.

An exposure method in this embodiment will be explained next. After a wafer 5 is loaded into the measurement station 1, the stage reference mark 11 is detected by the wafer alignment detection system 13. To do this, the controller C moves the X-Y stage while monitoring the output from the laser interferometer so that the optical axis of the wafer alignment detection system 13 coincides with the stage reference mark 11. With this operation, the wafer alignment detection system 13 measures the position information of the stage reference mark 11 within a coordinate system defined by the laser interferometer. Similarly, the focus detection system 12 detects the surface position information of the stage reference mark 11 in the measurement station 1.

The positions of respective shot regions on the wafer 5 are detected. The controller C moves the wafer stage 6 while monitoring the output from the laser interferometer so that the optical axis of the wafer alignment detection system 13 coincides with the wafer alignment marks in the peripheries of respective shot regions on the wafer 5. In the process of the movement, the wafer alignment detection system 13 detects the wafer alignment marks formed in the peripheries of respective shot regions on the wafer 5. With this operation, the position of each wafer alignment mark within a coordinate system defined by the laser interferometer is detected. Although an overview of wafer alignment measurement has already been described in relation to the prior art, an exposure apparatus to which the present invention is applied performs pre-alignment measurement different from that described earlier, and a detailed description thereof will be given later. The positional relationships between the stage reference mark 11 and the respective wafer alignment marks are obtained based on the detection results of the stage reference mark 11 and the respective wafer alignment marks obtained by the wafer alignment detection system 13. Since the positional relationships between the respective wafer alignment marks and the respective shot regions are known, those between the stage reference mark 11 and the respective shot regions on the wafer 5 within the X-Y plane are, in turn, determined. The focus detection system 12 detects the pieces of surface position information of the wafer 5 for all shot regions defined on it. The detection results are stored in the controller C in correspondence with the position in the X and Y directions within a coordinate system defined by the laser interferometer. The positional relationships between the surface of the stage reference mark 11 and the surface of the wafer 5 in respective shot regions defined on it are determined based on the detection results of the surface position information of the stage reference mark 11 and the pieces of surface position information of the wafer 5 in all shot regions defined on it, which are obtained by the focus detection system 12.

Based on the results of the measurement process for the wafer 5 in the measurement station 1, the wafer 5 is exposed in the exposure station 2. The controller C moves the X-Y stage so as to detect the stage reference mark 11 using the reticle alignment detection system. The reticle alignment detection system detects the stage reference mark 11 via the reticle reference mark 10 and projection optical system 9. That is, the positional relationships between the reticle reference mark 10 and the stage reference mark 11 in the X and Y directions and in the Z direction are detected via the projection optical system 9. With this operation, the position of a reticle pattern image projected onto the wafer 5 by the projection optical system 9 is detected using the stage reference mark 11 via the projection optical system 9. After the position detection of a reticle pattern image formed by the projection optical system 9 is completed, the controller C moves the X-Y stage to move each shot region on the wafer 5 to a position below the projection optical system 9 in order to expose the shot regions on the wafer 5. The controller C performs a scan exposure of each shot region on the wafer 5 using each measurement result obtained in the measurement station 1.

During the exposure, each shot region on the wafer 5 and the reticle 3 are aligned with each other based on the positional relationships between the stage reference mark 11 and the respective shot regions, which are obtained in the measurement station 1, and the relationship between the position of the stage reference mark 11 and the position where the reticle pattern image is projected, which is obtained in the exposure station 2. Also during the scan exposure, the positional relationship between the surface of the wafer 5 and the plane onto which the reticle pattern image is projected by the projection optical system 9 is adjusted. This adjustment is performed based on the positional relationship between the surface of the stage reference mark 11 and the surface of the wafer 5, which is obtained in the measurement station 1, and that between the surface of the stage reference mark 11 and the plane on which the reticle pattern image is formed by the projection optical system 9, which is obtained in the exposure station 2. An overview of an exposure method for an exposure apparatus to which the present invention is applied has been described above.

An embodiment of pre-alignment measurement in wafer alignment measurement as a feature of the present invention will be described in detail below. In pre-alignment measurement, one pre-alignment mark in each of two shots is normally measured, but two pre-alignment marks in each of two shots are measured in this embodiment. This reduces the probability that each pre-alignment measurement likewise results in an erroneous measurement. Also, the subsequent process is continued by selecting an appropriate pre-alignment mark even when the erroneous measurement has occurred.

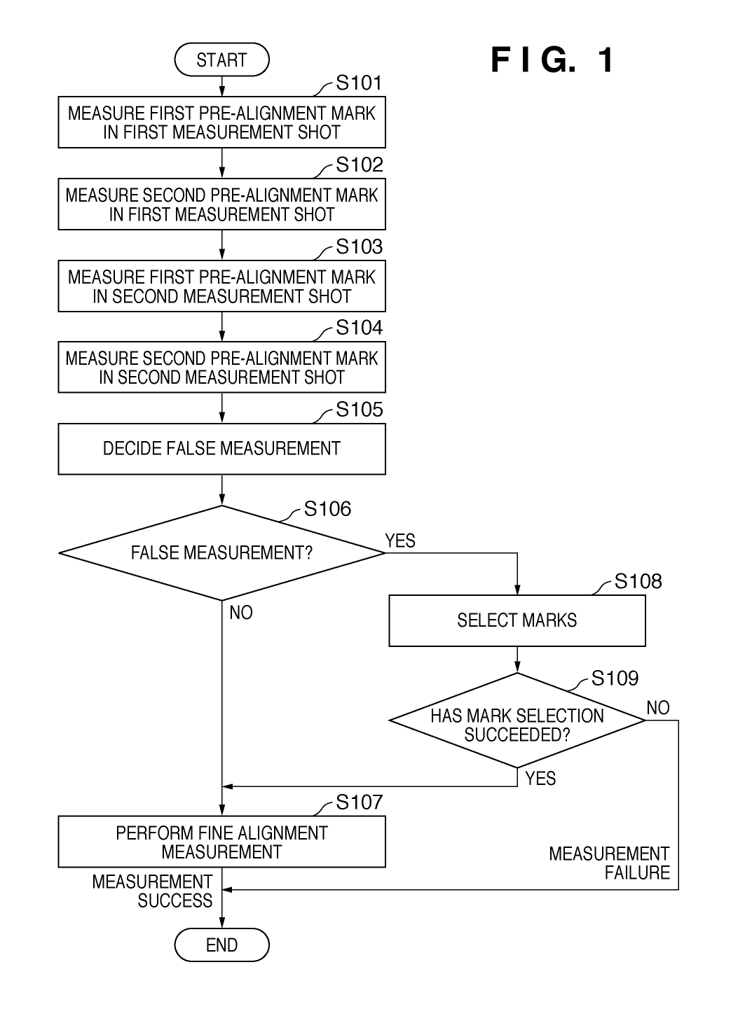

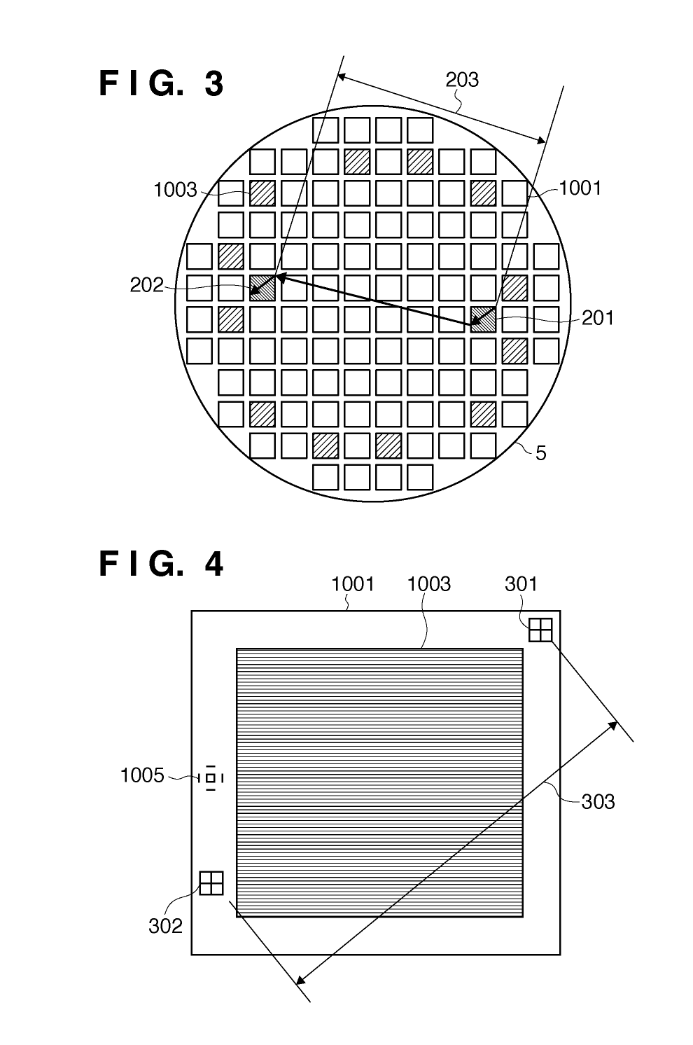

FIG. 1 is a flowchart illustrating an example of pre-alignment measurement. FIG. 3 schematically depicts an example of the measurement sequence of pre-alignment marks, and FIG. 4 schematically depicts an example of a shot. In step S101, the detector (wafer alignment detection system) 13 which detects a mark formed in a shot to undergo pre-alignment measurement measures a first pre-alignment mark (first mark) 301 in a first measurement shot 201 first. More specifically, the first mark 301 is brought into the field of view of the wafer alignment detection system 13 by driving the wafer stage 6. After the first mark 301 stops in the field of view of the wafer alignment detection system 13, the wafer alignment detection system 13 senses a mark image. The position of the sensed mark image is matched with a template as described in relation to the prior art. In step S102, the wafer alignment detection system 13 measures a second pre-alignment mark (second mark) 302 in the first measurement shot 201. The first mark 301 is formed at a position which satisfies a first positional relationship with the reference position in each measurement shot, whereas the second mark 302 is formed at a position which satisfies a second positional relationship with the reference position.

In step S103, the wafer alignment detection system 13 measures a first mark 301 in a second measurement shot 202. In step S104, the wafer alignment detection system 13 measures a second mark 302 in the second measurement shot 202. The same measurement method as in step S101 is adopted in both steps S103 and S104, and a description thereof will not be given.

In step S105 to decide an erroneous measurement, the controller C calculates a distance 303 (FIG. 4) between two marks from the measurement values of the first mark 301 and second mark 302 in the first measurement shot 201. Similarly, the controller C also calculates the distance between two marks in the second measurement shot 202. The controller C then decides, whether the distances each between two marks fall within or outside a tolerance, based on whether the differences between a design value and the measurement values of the distances each between two marks are equal to or larger than a preset threshold. If the distances each between two marks fall outside the tolerance, the controller C decides that an erroneous measurement has occurred. If the controller C decides in step S106 that an erroneous measurement has occurred, the process advances to step S108. If the controller C decides that no erroneous measurement has occurred, the process directly advances to step S107. In step S107, the controller C calculates the shift, rotation, and magnification of the wafer (the shot array on the wafer) using the measurement values obtained in steps S101 to S104.

In step S108, the controller C determines which of the first mark 301 and the second mark 302 has undergone the erroneous measurement. More specifically, the controller C calculates a distance 203 (FIG. 3) between the first marks in the first measurement shot 201 and second measurement shot 202, and the distance between the second marks in these shots as well. If there are two marks which have a measurement value of the distance 203 between them, that has a smaller difference from a design value than the other two marks and that is smaller than the preset threshold, the controller C decides these marks as marks which have undergone no erroneous measurement. If the controller C decides in step S109 that selectable marks are present, the process advances to step S107, in which the controller C calculates the wafer shift, rotation, and magnification using the measurement values of the selected marks. If the controller C decides in step S109 that selectable marks are absent, it decides that the pre-alignment measurement has failed and cancels the process.

An example in which a process of determining selectable marks by the controller C (S108) is performed after the controller C decides that an erroneous measurement has occurred in pre-alignment measurement has been explained in this embodiment. As a matter of course, the present invention is not limited to this, and the controller C may decide that the pre-alignment measurement has failed and cancel the process at the time point when it decides that an erroneous measurement has occurred (S106). After the pre-alignment measurement has failed and the process is cancelled, the process waits until the user issues an instruction. If the measurement has succeeded (when step S106 is executed), the process advances to fine alignment, in which fine alignment measurement is performed based on the wafer shift, rotation, and magnification calculated in the pre-alignment measurement.

In this embodiment, it is possible to reliably detect the erroneous measurement by alignment measurement using two or more alignment marks in each shot. It is also possible to continue the subsequent process by selecting a measurement value free from an erroneous measurement when the erroneous measurement has occurred.

### Second Embodiment

The second embodiment will be described. Overviews of an exposure method and exposure apparatus in the second embodiment are the same as those described with reference to FIG. 2 in the first embodiment, and a description thereof will not be given. In the first embodiment, pre-alignment measurement is performed using two marks in each of two measurement shots to detect the occurrence of an erroneous measurement. In the second embodiment, pre-alignment measurement is normally performed using one mark in each of two measurement shots, but is performed using two marks in each of two measurement shots only when the measurement value has low reliability. This makes it possible to shorten the pre-alignment measurement process time as compared with the first embodiment while obtaining the same effect as in this embodiment.

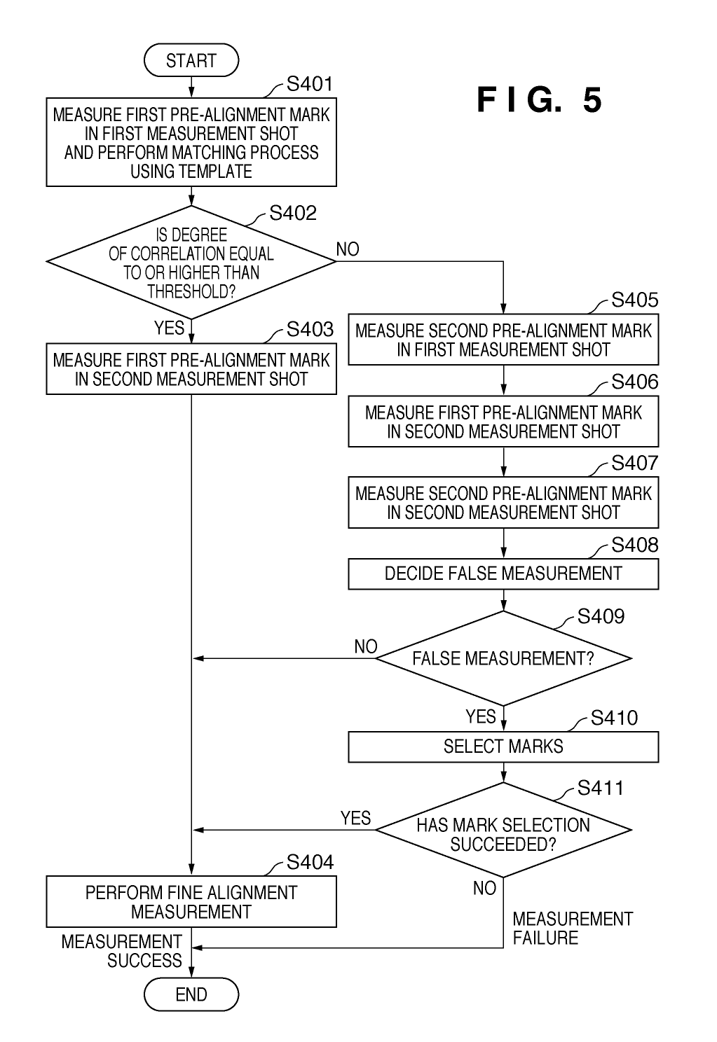

FIG. 5 is a flowchart illustrating an example of this pre-alignment measurement. In step S401, a wafer alignment detection system 13 measures a first mark 301 in a first measurement shot 201 first. More specifically, the first mark 301 is brought into the field of view of the wafer alignment detection system 13 by driving a wafer stage. After the first mark 301 stops in the field of view of the wafer alignment detection system 13, the wafer alignment detection system 13 senses a mark image. The position of the sensed mark image undergoes a matching process using a template. In step S402, a controller C decides whether the degree of matching (degree of correlation) in the matching process is equal to or higher than a preset threshold. If the controller C decides in step S402 that the degree of correlation is equal to or higher than the threshold, the measurement value has high reliability, so the process advances to step S403. Japanese Patent Laid-Open No. 2003-338455 describes details of this matching process using a template. In step S403, the wafer alignment detection system 13 measures a first mark 301 in the next second measurement shot 202. The same measurement method as in step S401 is adopted in step S403, and a description thereof will not be given. The process then advances to step S404. In step S404, the controller C calculates the shift, rotation, and magnification of the wafer (the shot array on the wafer) using the measurement values obtained in steps S401 and S403, and the process ends.

If the controller C decides in step S402 that the degree of correlation is lower than the threshold, the measurement value has low reliability, so the process advances to step S405 in order to perform measurement in all measurement shots. In step S405, the wafer alignment detection system 13 measures a second mark 302 in the first measurement shot 201. In step S406, the wafer alignment detection system 13 measures the first mark 301 in the second measurement shot 202. In step S407, the wafer alignment detection system 13 measures the second mark 302 in the second measurement shot 202. The same measurement method as in step S401 is adopted in steps S406 and S407, and a description thereof will not be given. In step S408 to decide an erroneous measurement, the controller C calculates the distance (a distance 303 shown in FIG. 4) between marks from the measurement values of the first mark 301 and second mark 302 in the first measurement shot 201. Similarly, the controller C also calculates the distance between marks in the second measurement shot 202. If the differences between a design value and the measurement values of these distances between marks are equal to or larger than a preset threshold, the controller C decides that an erroneous measurement has occurred. If the controller C decides in step S409 that an erroneous measurement has occurred, the process advances to step S410. In contrast, if the controller C decides in step S409 that no erroneous measurement has occurred, the process advances to step S404. In step S404, the controller C calculates the shift, rotation, and magnification of the wafer (the shot array on the wafer) using the measurement values obtained in steps S401 and S405 to S407. In step S401, the controller C determines which of the first mark 301 and the second mark 302 has undergone the erroneous measurement. More specifically, the controller C calculates a distance 203 (FIG. 3) between the first marks 301 in the first measurement shot 201 and the second measurement shot 202, and the distance between the second marks 302 as well. If there are two marks which have a measurement value of the distance 203 between them, that has a smaller difference from a design value than the other two marks and that is smaller than the preset threshold, the controller C selects these marks as pre-alignment marks which have undergone no erroneous measurement. If the controller C decides in step S411 that selectable marks are present, the process advances to step S404, in which the controller C calculates the wafer shift, rotation, and magnification using the measurement values of the selected marks. If the controller C decides in step S411 that selectable marks are absent, it decides that the pre-alignment measurement has failed and cancels the process. An example in which the controller C calculates a selectable pre-alignment mark in step S410 after it decides that an erroneous measurement has occurred in pre-alignment measurement has been explained in the second embodiment. As a matter of course, the present invention is not limited to this, and the controller C may decide that the pre-alignment measurement has failed and cancel the process at the time point when it decides that an erroneous measurement has occurred (S409). After the pre-alignment measurement has failed and the process is cancelled, the process waits until the user issues an instruction. If the measurement has succeeded (when step S404 is executed), the process advances to fine alignment, in which fine alignment measurement is performed based on the wafer shift, rotation, and magnification calculated in the pre-alignment measurement.

Although it is decided whether to perform a step of deciding an erroneous measurement based on the degree of correlation in a template matching process in pre-alignment measurement in this embodiment, the present invention is not limited to this. The same effect can be obtained even by deciding whether to decide an erroneous measurement based on, for example, the contrast of the sensed mark image. In this embodiment, alignment measurement is normally performed using one alignment mark in each shot, but is performed using two or more alignment marks in each shot when the measurement value has low reliability. This makes it possible to reliably detect an erroneous measurement while shortening the alignment measurement process time as compared with the first embodiment. It is also possible to continue the subsequent process by selecting a measurement value free from an erroneous measurement when the erroneous measurement has occurred.

### Third Embodiment

An exposure method in the third embodiment will be described. Overviews of an exposure method and exposure apparatus in the third embodiment are the same as those described with reference to FIG. 2 in the first embodiment, and a description thereof will not be given. In the first and second embodiments, pre-alignment measurement is performed using two marks in each of two shots to detect the occurrence of an erroneous measurement. In the third embodiment, pre-alignment measurement is performed using one mark in each of two shots, these marks being different from each other. This makes it possible to shorten the pre-alignment measurement process time as compared with the first and second embodiments while obtaining the same effect as in these embodiments.

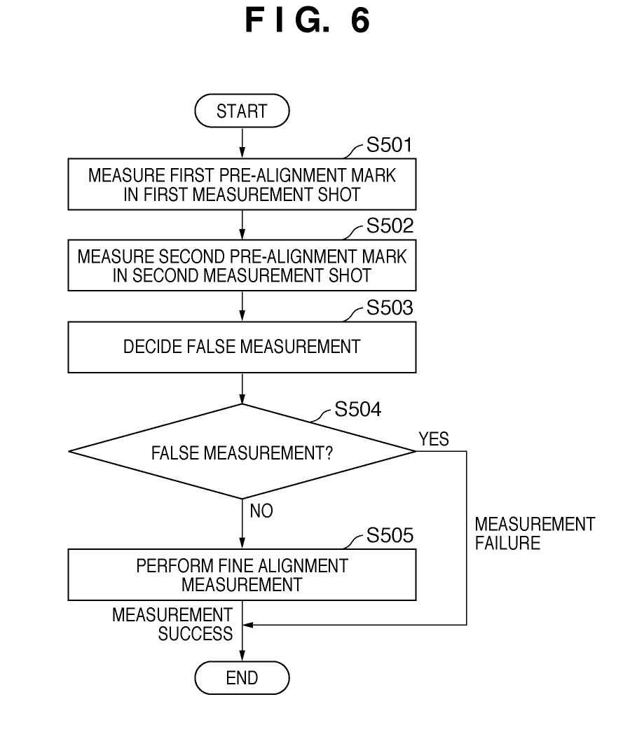

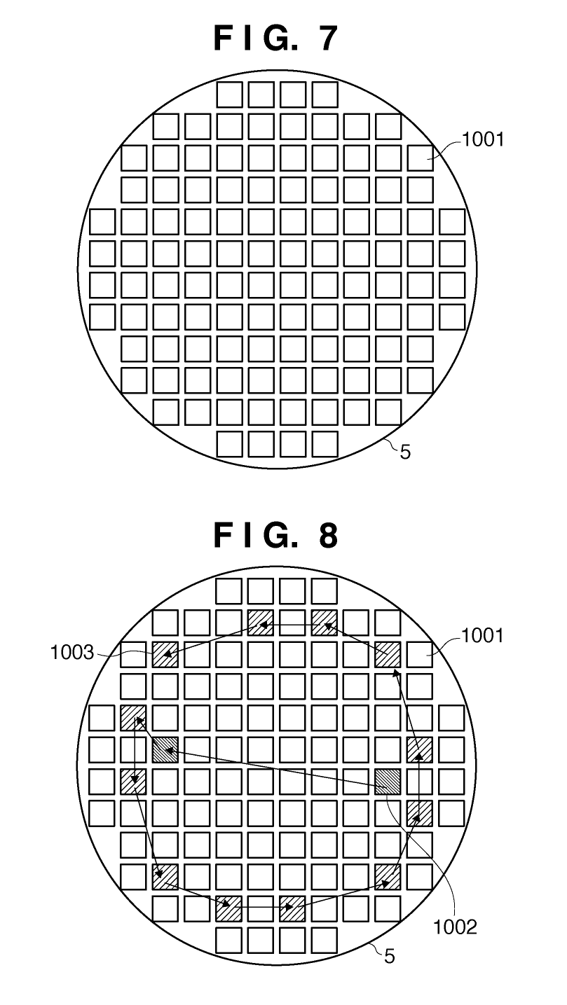

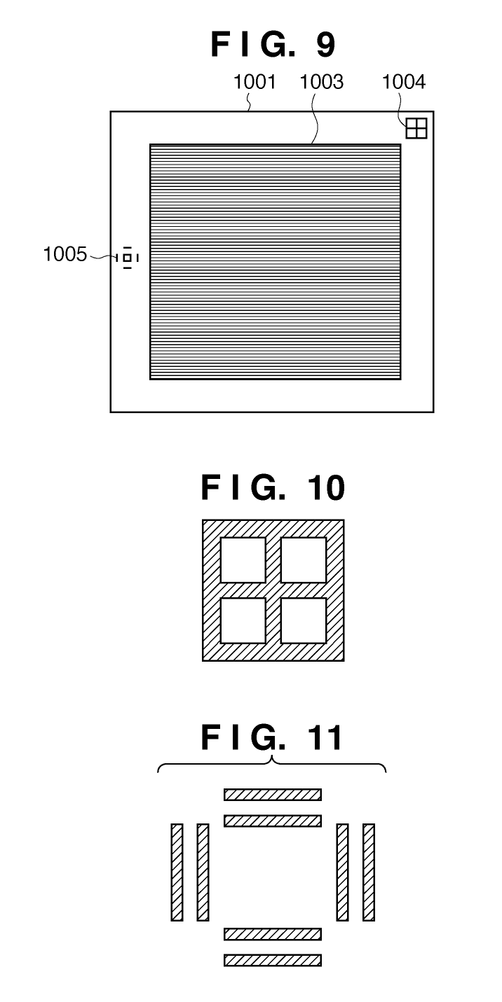

FIG. 6 is a flowchart of pre-alignment measurement. In step S501, a wafer alignment detection system 13 measures a first mark 301 in a first measurement shot 201 first. More specifically, the first mark 301 is brought into the field of view of the wafer alignment detection system 13 by driving a wafer stage. After the first mark 301 stops in the field of view of the wafer alignment detection system 13, the wafer alignment detection system 13 senses a mark image. The position of the sensed mark image is matched with a template as described in relation to the prior art. In step S502, the wafer alignment detection system 13 measures a second mark 302 in a second measurement shot 202. The same measurement method as in step S501 is adopted in step S502, and a description thereof will not be given. In step S503 to decide an erroneous measurement, a controller C calculates the distance (not shown) between marks from the measurement value of the first mark 301 in the first measurement shot 201 obtained in step S501 and that of the second mark 302 in the second measurement shot 202 obtained in step S502. If the difference between a design value and the measurement value of this distance between marks is equal to or larger than a preset threshold, the controller C decides that an erroneous measurement has occurred.

If the controller C decides in step S504 that an erroneous measurement has occurred, it decides that the pre-alignment measurement has failed and cancels the process. In contrast, if the controller C decides in step S504 that no erroneous measurement has occurred, the process advances to step S505. In step S505, the controller C calculates the shift, rotation, and magnification of the wafer (the shot array on the wafer) using the measurement values obtained in steps S501 and S502. After the pre-alignment measurement has failed and the process is cancelled, the process waits until the user issues an instruction. If the measurement has succeeded, the process advances to fine alignment, in which fine alignment measurement is performed based on the wafer shift, rotation, and magnification calculated in the pre-alignment measurement.

A combination of the first mark 301 in the first measurement shot 201 and the second mark 302 in the second measurement shot 202 is adopted in this embodiment. However, the present invention is not limited to this, and any combination of pre-alignment marks at different positions in shots may be adopted. In this embodiment, an erroneous measurement is easy to detect because of the adoption of pre-alignment marks at in-shot positions that differ for each measurement shot. In this embodiment, it is possible to reliably detect an erroneous measurement while shortening the alignment measurement process time as compared with the first and second embodiments by alignment measurement using different alignment marks in respective measurement shots.

Although an example in which two shots are used as measurement shots and two marks are used in each shot as alignment marks in pre-alignment measurement has been explained in each embodiment, the present invention is not limited to this. The present invention can obtain the same effect even when one or three or more measurement shots are used and three or more alignment marks are used in each shot. Although pre-alignment measurement operations of two alignment marks in a shot are independently performed (steps S101 and S102 and steps S401 and S405) by driving the wafer stage in the interval between these measurement operations in the first and second embodiments, the present invention is not limited to this. If two alignment marks are adjacent to each other and fall within the same measurement field of view, they may be measured at once. The same applies to measurement of alignment marks in the other shot (steps S103 and S104 and steps S406 and S407). This makes it possible to shorten the pre-alignment measurement process time while obtaining the same effect by decreasing the number of times of driving of the wafer stage in measuring a plurality of alignment marks in one shot. The present invention can obtain the same effect even when it is applied to fine alignment measurement. Moreover, although an example in which the position in two orthogonal directions is measured in each pre-alignment mark has been explained in each embodiment, the present invention is not limited to this. The present invention can obtain the same effect even when the position in one direction is measured. Although processing of one wafer has been exemplified in the first and second embodiments, this processing is not always performed for all wafers in the same lot. Wafers in the same lot have alignment marks with similar characteristics. For this reason, an exposure apparatus can continuously expose a plurality of wafers by performing an erroneous measurement decision and determination of marks having undergone no erroneous measurement for only the first wafer in a lot. In this case, the second and subsequent wafers undergo pre-alignment measurement based on the erroneous measurement decision result and the determination of marks having undergone no erroneous measurement for the first wafer. This makes it possible to further shorten the time to process wafers in a lot while obtaining the same effect.

### Method of Manufacturing Device

A method of manufacturing a device such as a semiconductor device or a liquid crystal device will be exemplified next. The device is manufactured by an exposure step of exposing a substrate using the exposure apparatus according to the first to third embodiments, a development step of developing the substrate exposed in the exposure step, and subsequent known steps of processing the substrate developed in the development step. The subsequent known steps include, for example, etching, resist removal, dicing, bonding, and packaging steps.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-135353, filed Jun. 4, 2009, which is hereby incorporated by reference herein in its entirety.

What is claimed is:

1. An apparatus which performs an alignment measurement for a mark of each of at least two shots selected from a plurality of shots on a substrate, and positions the substrate based on the alignment measurements to transfer a pattern to each the plurality of shots, the apparatus comprising:
a detector configured to detect the mark; and
a controller configured to control the alignment measurements, wherein
the controller is configured to
cause the detector to detect two of the mark, and
decide whether the alignment measurements include an erroneous measurement based on whether a distance between the two of the mark detected by the detector is outside a tolerance.

2. The apparatus according to claim 1, wherein the alignment measurement includes a pre-alignment measurement performed for a mark of each of at least two shots selected from the plurality of shots, and a fine alignment measurement performed for a mark of each of at least two shots selected from the plurality of shots, the fine alignment measurement being performed based on the pre-alignment measurements.

3. The apparatus according to claim 1, wherein
each of the plurality of shots has a first mark and a second mark, and
the controller is configured to decide whether the alignment measurements include an erroneous measurement based on whether a distance between the first mark and the second mark of one of the plurality of shots detected by the detector is outside the tolerance.

4. The apparatus according to claim 3, wherein if the controller decides that the alignment measurements include an erroneous measurement, the controller is configured to determine a mark which has not undergone the erroneous measurement, and to obtain measured values of the alignment measurements based on the determined mark.

5. The apparatus according to claim 4, wherein if one of a distance between the first marks and a distance between the second marks of two of the plurality of shots detected by the detector is within the tolerance, the controller is configured to determine marks of which the distance is within the tolerance as marks which have not undergone the erroneous measurement.

6. The apparatus according to claim 4, wherein if the pattern is transferred to a plurality of substrates in a lot, the controller is configured to decide whether the alignment measurements for a first substrate include the erroneous measurement, to determine marks which have not undergone the erroneous measurement if the alignment measurements for the first substrate include the erroneous measurement, and to control the alignment measurements for a subsequent substrate in the lot in accordance with the decision and the determination for the first substrate.

7. The apparatus according to claim 1, wherein
each of the plurality of shots has a first mark and a second mark, and
said controller is configured to decide whether the alignment measurements include the erroneous measurement based on whether a distance between the first mark in one of the plurality of shots and the second mark in another of the plurality of shots, which are detected by the detector, is outside the tolerance.

8. The apparatus according to claim 1, wherein the controller is configured to decide whether to decide whether the alignment measurements include the erroneous measurement based on a template matching performed by the detector to detect the marks.

9. The apparatus according to claim 8, wherein if a degree of correlation obtained by the template matching is outside the tolerance, the controller is configured to decide to decide whether the alignment measurements include the erroneous measurement.

10. A method of manufacturing a device, the method comprising:
transferring a pattern to a substrate using an apparatus; and
processing the substrate to which the pattern has been transferred to manufacture the device, wherein
the apparatus is configured such that the apparatus performs an alignment measurement for a mark of each of at least two shots selected from a plurality of shots on a substrate, and positions the substrate based on the alignment measurements to transfer a pattern to each the plurality of shots, the apparatus comprising:
a detector configured to detect the mark; and
a controller configured to control the alignment measurements, wherein
the controller is configured to
cause the detector to detect two of the mark, and
decide whether the alignment measurements include an erroneous measurement based on whether a distance between the two of the mark detected by the detector is outside a tolerance.
